(19) United States
(12) Patent Application Publication
(10) Pub. No.: US 2024/0327636 A1
(43) Pub. Date: Oct. 3, 2024

(54) BIODEGRADABLE RESIN COMPOSITION AND BIOMASS NANOFIBER PARTICLE

(71) Applicant: SUGINO MACHINE LIMITED, Namerikawa City (JP)

(72) Inventor: ATSUSHI MINEMURA, Namerikawa City (JP)

(73) Assignee: SUGINO MACHINE LIMITED, Namerikawa City (JP)

(21) Appl. No.: 18/619,208

(22) Filed: Mar. 28, 2024

(30) Foreign Application Priority Data
Mar. 28, 2023 (JP) 2023-051298

(51) Int. Cl. C08L 67/04; C08B 15/02

(52) U.S. Cl. CPC C08L 67/04; C08B 15/02; C08L 2201/06; C08L 2205/16

(57) ABSTRACT

The present disclosure provides a biodegradable resin composition, which has a good tensile strength and an enhanced impact resistance compared with previous biodegradable resins. The biodegradable resin composition includes a biomass nanofiber and a biodegradable resin, where the content of the biomass nanofiber ranges from 0.1% to 10% by mass.

### TECHNICAL FIELD

The present disclosure relates to a biodegradable resin composition and biomass nanofiber particles used in the biodegradable resin composition.

### BACKGROUND OF THE INVENTION

Biodegradable plastics eventually decompose into water and carbon dioxide under the action of microorganisms, so the problem of waste treatment is expected to be solved. However, biodegradable plastics, when in the form of molded articles, have reduced strength to ensure biodegradability.

In addition, in recent years, the rising oil prices or oil depletion risks and the global warming caused by the increase in carbon dioxide emissions are of great concern. In order to solve these problems, new materials derived from biomass have drawn more and more attention. Progress has been made in the production methods and the development of various applications of cellulose nanofibers as a new material.

In order to enhance the strength of biodegradable plastics without impairing their biodegradability, a biodegradable composite material is proposed in Patent Document 1, where a cellulose nanofiber is mixed with a biodegradable resin to form the biodegradable composite material with biodegradability and promoted strength.

### PRIOR ART DOCUMENT

### Patent Document

Patent document 1: JP No. 2021-21041A.

In Patent Document 1, various strengths and biodegradability are evaluated, but impact resistance is not studied. In the examples of Patent Document 1, the content of the cellulose nanofiber is more than 20% by mass, enhancing various strengths, but in this case, the impact resistance may be degraded.

### SUMMARY OF THE INVENTION

The present disclosure provides a biodegradable resin composition, which has a good tensile strength and an enhanced impact resistance compared to previous biodegradable resins.

The inventors have conducted thorough research to bring about the following technical solutions, and the present disclosure is as follows.
(1) A biodegradable resin composition, including a biomass nanofiber and a biodegradable resin, where a content of the biomass nanofiber ranges from 0.1% to 10% by mass.
(2) In the biodegradable resin composition as described in (1), the content of the biomass nanofiber ranges from 0.8% to 8% by mass.
(3) In the biodegradable resin composition as described in (1) or (2), the biomass nanofiber is a mechanical defibrating biomass nanofiber.
(4) In the biodegradable resin composition as described in any one of (1) to (3), a polymerization degree of the biomass nanofiber ranges from 150 to 900.
(5) A biomass nanofiber particle, formed by the biomass nanofiber and used in the biodegradable resin composition as described in any one of (1) to (4), is granular, where the biomass nanofiber particle includes multiple agglomerated biomass nanofibers having an average fiber diameter of 5 nm to 50 nm, where a polymerization degree of the biomass nanofibers ranges from 150 to 900, where a water content of the biomass nanofiber particle is less than 9% by mass and a median particle size of the biomass nanofiber particle ranges from 3 μm to 15 μm.
(6) In the biomass nanofiber particle as described in (5), a content of at least one functional group selected from a group consisting of carboxyl, carboxymethyl, phosphate, sulfate, phosphite, xanthate, and sulfo is less than 0.1 mmol/g.

In the present disclosure, a biodegradable resin composition is provided, where the biodegradable resin composition has a good tensile strength and an enhanced impact resistance compared with previous biodegradable resins.

### DETAILED DESCRIPTION OF THE INVENTION

Hereinafter, a biodegradable resin composition and a biomass nanofiber particle according to an embodiment (this embodiment) of the present disclosure will be illustrated below.

### (Biodegradable Resin Composition)

The biodegradable resin composition according to this embodiment includes a biomass nanofiber and a biodegradable resin, where the content of the biomass nanofiber ranges from 0.1% to 10% by mass. If the content of the biomass nanofiber is less than 0.1% by mass, the biodegradable resin composition can't have a good tensile strength and an enhanced impact resistance compared with previous biodegradable resins.

From the viewpoints of having a good tensile strength and an enhanced impact resistance more reliably, the content of the biomass nanofiber preferably ranges from 0.8% to 8% by mass, more preferably 1% to 7% by mass.

### (Biomass Nanofiber)

The biomass nanofiber (BNF) according to this embodiment is a nanofiber derived from a biological polymer and insoluble in water, for example, a cellulose nanofiber, a chitin nanofiber, a chitosan nanofiber, and a silk nanofiber, where the cellulose nanofiber (CNF) is preferred due to its chemical stability, thermal stability, and low cost.

The average fiber diameter of the biomass nanofiber preferably ranges from 5 nm to 100 nm, more preferably 6 nm to 50 nm, further preferably 7 nm to 40 nm, furthermore preferably 8 nm to 25 nm, and particularly preferably 8 nm to 15 nm.

The average length of the biomass nanofiber preferably ranges from 0.5 μm to 100 μm, and more preferably 10 μm to 100 μm.

The average fiber diameter or average length of the biomass nanofiber can be calculated according to the fiber diameter or length (n=20 or so, that is about 20 biomass nanofibers are used for calculating the average fiber diameter or average length) measured based on electron microscope photographs taken at an appropriate magnification.

Although there are biomass nanofibers produced by various production methods, mechanical defibrating biomass nanofibers produced by mechanical defibration are particularly preferred. The mechanical defibration includes using a beater or a refiner to make raw biomass have a specified length, and then using a high-pressure homogenizer, a grinder, an impact pulverizer, a bead mill, and so on to perform fibrillation or micronization (mechanical pulverization).

In another aspect, chemically modified biomass nanofibers are obtained by using chemical treatment to make raw biomass easily micronized, and then performing micronization by mechanical defibrating. Therefore, a chemically modified biomass nanofiber is chemically modified. For example, when using a chemically modified CNF such as a TEMPO oxidized CNF, metal ions contained in the salt may act as impurities. Metal ions are, for example, sodium, aluminum, copper, and silver. Due to that the mechanical defibrating biomass nanofibers are not subjected to chemical modification in the process of micronization and only water is used as the medium, there are no compounds that easily have any influence on the physical performance of resins, and the mechanical defibrating biomass nanofibers have chemical stability and thermal stability. Furthermore, even if the mechanical defibrating biomass nanofibers are treated with a high-pressure homogenizer, the polymerization degree of the mechanical defibrating biomass nanofibers hardly decreases.

Herein, the content of any one of sodium, aluminum, copper, and silver (preferably each of any two, and more preferably each of any three) in the mechanical defibrating biomass nanofibers is less than 0.1% by mass, and preferably less than 0.01% by mass.

In addition, the content of metal ions can be measured and determined by high-frequency inductively coupled plasma emission spectrometry, the EPMA method using an electron beam microanalyzer, and elemental analysis using X-ray fluorometry.

Compared with the production method using chemical modification, mechanical defibration can be achieved by the force of the water jet, and fewer impurities are introduced. In addition, compared with the production method using chemical modification, the polymerization or crystallinity degree of the raw material is less reduced. Compared with the production method using chemical modification, mechanical defibration further has the following advantages: the cleaning operation after chemical modification treatment is not needed, and the number of operations is less.

In the case where the mechanical defibrating biomass nanofiber is a cellulose nanofiber (i.e., mechanical defibrating cellulose nanofiber), the polymerization degree thereof preferably ranges from 150 to 900, and more preferably 400 to 900. By setting the polymerization degree to be more than 150, the impact resistance can be enhanced reliably. By setting the polymerization degree to be less than 900, the dispersibility of mechanical defibrating biomass nanofibers represented by the cellulose nanofiber in the resin can be improved.

The polymerization degree is the number of linkages of glucose units which are the smallest constituent unit of the cellulose, and can be determined by copper ethylenediamine method.

### (Biodegradable Resin)

Conventionally known resins can be used as biodegradable resin, for example: polyhydroxyalkanoic acids such as polyglycolic acid (PGA), polylactic acid (PLA), polyhydroxybutyrate (PHB) and poly(hydroxybutyrate hydroxyhexanoate) (PHBH); polyester resins such as polycaprolactone (PCL), poly(butylene succinate) (PBS), poly(caprolactone butylene succinate) (PCLBS), poly(butylene succinate-co-butylene adipate) (PBSA), poly(butylene carbonate) (PBC), poly(ethylene terephthalate succinate) (PETS), poly(tetramethylene adipate-co-terephthalate) (PBAT), poly(ethylene succinate) (PES), and poly(ethylene succinate adipate); (polylactic acid/polybutylene succinates) block copolymers; polyvinyl alcohol (PVA); a modified starch; cellulose acetate; chitin; chitosan; lignin; and so on, where polylactic acid (PLA) is preferred.

From the viewpoint of obtaining useful rigidity, a weight average molecular weight of the biodegradable resin is preferably more than 5,000, more preferably more than 50,000, and further preferably more than 100,000.

Furthermore, the weight average molecular weight is the average molecular weight of polystyrene equivalent measured by gel permeation chromatography (GPC) using tetrahydrofuran as a solvent.

The resin composition of this embodiment can be produced by the following operations: mixing the above-mentioned biomass nanofiber (preferably the biomass nanofiber particle described later) with the biodegradable resin and so on by an agitator, drying the mixture in a thermostatic bath at about 80° C., and then performing melting and kneading with a twin-screw kneader.

During the mixing above or in the biodegradable resin, the following can be added without damaging the properties of the resin, for example, effective crystallization promoters, such as sodium oxalate, calcium oxalate, sodium benzoate, calcium benzoate, calcium phthalate, calcium tartrate, magnesium stearate, higher fatty acids, higher fatty acid metal salts, higher fatty acid esters, and higher fatty acid amides; rubber components; plasticizers; ultraviolet inhibitors; heat stabilizers; light stabilizers; antifogging agents; antistatic agents; flame retardants; antioxidants; pigments; colorants; and so on.

In addition, from the viewpoints of having a good tensile strength and enhancing an impact resistance more reliably, in the biodegradable resin composition according to this embodiment, the content of the biomass nanofiber preferably ranges from 0.1 to 12 parts, more preferably 0.3 to 10 parts, and further preferably 0.7 to 8 parts, relative to 100 parts by mass of the biodegradable resin. That is the content of the biomass nanofiber preferably ranges from 0.1% to 12% by mass, more preferably 0.3% to 10% by mass, and further preferably 0.7% to 8% by mass.

The resin composition of this embodiment is, for example, granular, sheet-shaped, fibrous, plate-shaped, rod-shaped, etc., and a granular shape is more preferable from the viewpoint of post-treatment convenience or transportation convenience. The preferred granular shape further includes round, oval, cylindrical shapes, and so on, and these different shapes are formed by the cutting method during extrusion processing.

The resin composition of this embodiment can be used for producing various resin molded articles. There is no particular limitation on resin molding method, and various commonly known molding methods can be used, such as injection molding, extrusion molding, blow molding, inflation molding, and foam molding.

The resin composition of this embodiment has an excellent mechanical property (tensile elasticity) and impact resistance, so can be used for various components or products.

### (Biomass Nanofiber Particle)

The biomass nanofiber particle according to this embodiment is the biomass nanofiber particle used in the biodegradable resin composition of the present disclosure above, and is formed by biomass nanofibers.

The biomass nanofiber is the above-mentioned biomass nanofiber, and preferably a mechanical defibrating biomass nanofiber. In addition, the following biomass nanofiber particle is preferred.

The biomass nanofiber particle according to this embodiment is granular and is an aggregate of multiple biomass nanofibers, where an average fiber diameter of the biomass nanofibers ranges from 5 nm to 50 nm and a polymerization degree of the biomass nanofibers ranges from 150 to 900. A water content of the biomass nanofiber particle is less than 9% by mass, and a median particle size of the biomass nanofiber particle ranges from 3 μm to 15 μm.

Since the biomass nanofiber particle is granular and is an aggregate of multiple biomass nanofibers having an average fiber diameter of 5 nm to 50 nm, the aggregate of the biomass nanofibers disintegrates in the resin during melting and kneading, so that the biomass nanofibers can be highly dispersed in the resin.

By setting the polymerization degree of the biomass nanofiber to 150 to 900, the impact resistance can be enhanced more reliably, and the dispersibility of the biomass nanofiber in the resin can be improved. The polymerization degree more preferably ranges from 400 to 900, and further preferably 600 to 850.

Because the water content of the biomass nanofiber particle is low, which is less than 9% by mass, the biomass nanofiber particle is not easy to be hydrolyzed even if being added to the biodegradable resin, forming a more useful biodegradable resin composition. More preferably, the water content is less than 8% by mass. In addition, the water content is more preferably less than 7% by mass. In addition, the water content is more preferably less than 6% by mass, and further preferably less than 5% by mass. The water content can be measured by the method described in the examples.

By setting the median particle size of the biomass nanofiber particle to be 3 μm to 15 μm, the aggregates formed by the biomass nanofibers are prone to disintegrate in the resin during resin kneading, and the nanofiber can be well dispersed in the resin. The median particle size more preferably ranges from 3 μm to 12 μm, and further preferably 3 μm to 10 μm. The median particle size can be measured by the method described in the examples.

Moreover, in the biomass nanofiber particle, the content of at least one functional group (ionic functional group) selected from a group consisting of carboxyl, carboxymethyl, phosphate, sulfate, phosphite, xanthate, and sulfo is preferably less than 0.1 mmol/g.

By using the above-mentioned mechanical defibrating biomass nanofiber, the content of the ionic functional group can be allowed to be less than 0.1 mmol/g.

In the biomass nanofiber particle, by setting the content of the ionic functional group to be less than 0.1 mmol/g, the discoloration during kneading can be reduced, and the heat resistance of cellulose itself can be improved. The content of the ionic functional group is more preferably less than 0.08 mmol/g, and further preferably less than 0.02 mmol/g. The content of the ionic functional group can be measured by the method described in the examples.

In addition, it is more preferable that the total content of all ionic functional groups mentioned above is within the above range.

In the biomass nanofiber particle, from the viewpoints of the dispersibility in the resin, strength, and impact resistance, the BET specific surface area of the biomass nanofiber preferably ranges from 70 m²/g to 200 m²/g, and more preferably 90 m²/g to 150 m²/g.

The biomass nanofiber particle of this embodiment can be produced by drying BNF after preparing a BNF dispersion.

### (Preparation of BNF Dispersion)

Firstly, biomass nanofibers were dispersed in water to prepare a slurry serving as a biomass dispersion fluid. For example, the BNF according to this embodiment is CNF, which employs mechanically pulverizing cellulose as its fibers. Cellulose with crystal form I (type I cellulose), i.e., wood pulp, or non-wood pulp (such as cotton, linter, hemp, bacterial cellulose, and parenchyma cell fiber) can be used. In addition, cellulose with crystal form II (type II cellulose), i.e., a regenerated cellulose fiber and so on can be used, where N-methylmorpholine-N-oxide/water solvent, a copper ammonia complex, and sodium hydroxide/carbon disulfide are used as a dissolvent. Type II cellulose has a lower molecular weight and crystallinity degree, so its fiber is easier to be cut and its heat resistance is lower than that of type I cellulose, and thus type I cellulose is a preferred material. The method for mechanically pulverizing the raw cellulose includes the following: using a beater or a refiner to make the slurry have a specified length, and then using a high-pressure homogenizer, a grinder, an impact pulverizer, a bead mill, and so on to perform fibrillation or micronization, so as to achieve the mechanical pulverization.

Preferably, the preparation method for BNF includes allowing the biomass dispersion fluid to pass through a nozzle with a diameter of 0.1 mm to 0.8 mm, performing defibration by colliding the biomass dispersion fluid with a hard body after being ejected under a high pressure of 100 MPa to 245 MPa.

As the commercially available high-pressure homogenizer, the defibrating method described above allows the biomass dispersion fluid to pass through a narrow flow path at high pressure and low speed, and realizes continuous treatments under a high pressure due to not only the homogenized shear force during the ejection, but also the collision force or the cavitation phenomenon generated by the collision between the biomass dispersion fluid and the hard body. The defibrating method using the shear force, the collision force, and the cavitation phenomenon of these water jets (WJ) is defined as a WJ method. In addition, one collision treatment is regarded as one operation, in order to obtain uniform nanofibers, 1 to 30 times repeated collision is preferred, further 5 to 20 times repeated collision is preferable.

In addition, the WJ method does not need acids or alkalies, therefore, for example, the damage to the molecular chain of cellulose is small, such that a CNF with a higher crystallinity degree can be obtained. Furthermore, in the case of cellulose, the crystallinity degree under each operation (collision) is 40% to 83%; in the case of chitin, the crystallinity degree under each operation (collision) is 48% to 73%. Compared with other physical pulverization methods, such as a ball mill or a disc mill, where the crystallinity degree decreases continuously, one of the advantages of the WJ method is that the crystallinity degree hardly reduces.

Moreover, compared with the usual defibration process for the biomass dispersion fluid with a concentration of 1% to 2% by mass, the WJ method, which allows the biomass dispersion fluid with a maximum concentration of 30% by mass to pass through the nozzle with a diameter of 0.1 mm to 0.8 mm and then to collide with the hard body under high pressure of 100 MPa to 245 MPa to realize defibration, significantly increases the solid component treating capacity per unit. Thus, a BNF dispersion can be obtained with a low cost, low environmental impact, and high efficiency.

### (Drying of BNF)

Preferably, the drying of the BNF includes: after preheating, performing a constant-speed drying on the BNF dispersion or a liquid containing the BNF dispersion located in a drying device (during the drying process, the water content decreases by a certain ratio over time under a certain heating condition), where the drying speed ranges from 0.0002 to 0.5 (kg/m²·s). The liquid may be formed by mixing the BNF dispersion with organic components.

The drying speed can be calculated as follows.

$$R = - 1 / A \cdot dmw / d θ = rm / A ( kg / {m}^{2} \cdot s ) \\ rm = - dms / d θ$$

where R (kg/m²·s): drying speed;

A (m²): evaporation area;

mw (kg): mass of the water in the wet material;

θ (s): time;

rm (kg/s): loss rate of mass of the wet material before drying;

ms (kg): mass of the wet material.

In the case when the drying speed of the drying of the BNF produced by the WJ method is within the above range of 0.0002 to 0.5 (kg/m²·s), firm coagulation will not occur during the drying, and thus the dispersibility in the resin can be enhanced. In another aspect, when the drying speed is less than 0.0002 (kg/m²·s), the dispersibility is dramatically decreased. As long as the drying speed of the drying method can be kept within the range of 0.0002 to 0.5 (kg/m²·s), any suitable drying device can be used and there is no specific limitation, for example, various commercially available drying devices can be used, specifically, in addition to a spray drying device using a spray drying method, a drying device using a vacuum drying method, an airflow drying device using an airflow drying method, a fluidized bed drying device using a fluidized bed drying method, and so on can be employed.

Spray drying is a method for producing dry powder by spraying a liquid or a mixture of a liquid and a solid (slurry) in the gas. Spray drying (“spray dry” or “spray drying”) is suitable for drying materials that are easily damaged by heat, such as food or medicine. Because the obtained dry powder has a stable particle size distribution, spray drying can also be used for drying products such as catalysts.

Vacuum drying is carried out under vacuum or reduced pressure. When the air pressure is reduced, the partial pressure of water vapor in the air drops, and the boiling point of water drops, so that the evaporation speed is accelerated, and the drying of an object can be accelerated.

Airflow drying includes transporting powder, wet, muddy, or lumpy materials rapidly in a high-speed hot airflow at 300° C. to 600° C., so that the drying of the materials can be completed in a few seconds. A speed of the hot airflow in the airflow drying tube usually ranges from about 10 m/s to 30 m/s, and the heat transfer efficiency is high.

Fluidized bed drying includes making powder flow by blowing in a drying gas, and utilizing the excellent mixing, gas contact, and heat transfer characteristics of the fluidized bed to perform the drying. The material to be dried from one end enters the flow chamber and is discharged from the outlet while flowing in suspension. Sometimes, the moving speed, flow state, and so on of the material to be dried are properly adjusted, or a partition plate is inserted.

The spray drier for spray drying and conditions thereof can refer to, for example, the spray drier and conditions thereof described in JP2019-131772A and JP2019-131774A, and thus biomass nanofiber particles with the water content of less than 10% by mass can be produced.

Furthermore, by adjusting the drying speed into the range of 0.0002 to 0.5 (kg/m²·s), the water content of the biomass nanofiber particles can be kept at less than 9% by mass.

The storage temperature of the biomass nanofiber particles obtained by the above production method preferably ranges from 4° C. to 40° C., and further preferably 4° C. to 30° C. In terms of the pressure, normal pressure is preferable. The humidity is more preferably less than 70%, and further preferably less than 60%.

In the case of storing biomass nanofiber particles, for example, it is preferable to put them into an aluminum bag or a container that can be sealed, and then store them after sealing. In addition, the aluminum bag or sealed container can be transported as it was.

### EXAMPLES

### Example 1

### (Preparation of Cellulose Nanofiber Particle)

Ion-exchanged water was added to a CNF aqueous dispersion (BiNFi-s series WFo, polymerization degree: 650, produced by Sugino Machine Limited) until the final concentration was 1% by mass. The mixture was fully stirred and mixed with a three-in-one motor agitator BLW3000 (produced by SHINTO Scientific Co., Ltd), and dried using a spray drying device to obtain CNF dried bodies (i.e., cellulose nanofiber particle). The characteristics of CNF particle are shown in Table 1. The cellulose nanofiber particle is granular and an aggregate of multiple biomass nanofibers.

Furthermore, the water content of the cellulose nanofiber particle was measured by a heating and drying moisture meter (produced by A&D Company, Limited, product name: MX-50), and the corresponding result is 4.5% by mass.

In addition, the characteristics of the produced cellulose nanofiber particle are shown in Table 1 below.

TABLE 1

| | | |
|---|---|---|
| Characteristics | Polymerization degree of CNF | 650 |
| of CNF | Average fiber diameter of CNF (nm) | 9 |
| particle | Specific surface area of CNF (m²/g) | 120 |
| | Median particle size of CNF particle (μm) | 10.4 |
| | Ionic functional group content in CNF particle | 0.01 |
| | (mmol/g) | |
| | Crystalline structure of cellulose | Type I |

The median particle size of the CNF particle was measured by the laser diffraction/scattering particle size distribution measurement method (produced by Horiba Co., Ltd., device name: LA-960).

In terms of the content of ionic functional groups in the CNF particle, the content of ionic functional groups (the total content of carboxyl, carboxymethyl, phosphate, sulfate, phosphite, xanthate, and sulfo) was measured by conductometric titration method. The conductometric titration method includes treating the aqueous dispersion of the biomass nanofiber with an ion exchange resin, determining the change of the conductivity while adding sodium hydroxide aqueous solution.

The crystalline structure of cellulose in the Table 1 was measured by an X-ray diffractometer (produced by Rigaku Corporation, device name: rotating couple cathode type X-ray generator Rotaflex RU-200B), using the CuKα ray (A=1.542) passing through a Ni filter under an accelerating voltage of 40 kV and an accelerating current of 150 mA. A horizontal goniometer for powder X-ray diffraction produced by the same company was used to measure the diffraction intensity in the range of diffraction angle 2θ from 5° to 35°. In the diffraction curve (wide-angle X-ray diffraction image) obtained from the wide-angle X-ray diffraction image of cellulose fiber, the presence of typical peaks near the scanning angle 2θ=14° to 17° and 2θ=22° to 23° caused by cellulose type I crystalline confirms the presence of cellulose type I crystalline.

### (Preparation of Resin Composition)

The cellulose nanofiber particle (CNF particle), polylactic acid (TE-1030, produced by UNITIKA LTD.), a heat stabilizer (Irganox 168, produced by BASF Japan), and an antioxidant (Irgafos 1010, produced by BASF Japan) were mixed according to the ratio shown in Table 2, and stirred and mixed at a rotation speed of 20,000 rpm by an agitator for 1 minute. Then, the mixture was melted and kneaded by using a twin-screw kneader under the following conditions, temperature: 250° C., rotation speed: 100 rpm, and kneading time: 5 minutes. Dumbbell pieces with a length of 150 mm, a maximum width of 20 mm, a minimum width of 13 mm, and a thickness of 3.3 (ASTM D638 standard TYPE-1), and tests pieces for the Charpy impact test with a length of 80 mm, a width of 10 mm, and a thickness of 4 mm (JIS K7139 strip TYPE-B1) were obtained by injection molding (molding temperature was 250° C., and mold temperature was 40° C.). Each test piece can be regarded as a resin composition.

### (Evaluation)

The resin composition obtained was evaluated as follows. Furthermore, various evaluations were performed at room temperature (23° C.). The results are shown in the following table.

### Tensile Strength (Tensile Flexibility)

After adjusting the state of the obtained dumbbell pieces for 7 days, the tensile test was carried out by using a precision universal testing machine (produced by Shimadzu Co., Ltd., product name: Autograph AG-Xplus). The test conditions were as follows: the test speed was 10 mm/min and the distance between clamps was 60 mm. The measurement was performed according to JIS K7161.

### Charpy Impact Value

The test pieces produced for the Charpy impact test were used in the Charpy impact test.

The Charpy impact value was evaluated by the notched Charpy test (notch shape: A notch (the notch radius was 0.25 mm)). The measurement was performed according to JIS K7111 by using a digital impact tester (DG-UB produced by Toyo Seiki Inc.) as the measuring device, where the impact speed is 2.9 m/s, the nominal pendulum energy is 2 J or 4 J, the number of the test pieces n is 5 (i.e., n=5), and the evaluation item is energy absorption.

### Examples 2 to 5, Control Example 1

Except for the ratio shown as Example 1 of Table 2, resin compositions with other different ratios were prepared in the same manner as in Example 1. Then, the evaluation was performed in the same manner as in Example 1. The results are shown in the following table.

TABLE 2

| | | Control | Example | Example | Example | Example | Example |
|---|---|---|---|---|---|---|---|
| | | Example 1 | 1 | 2 | 3 | 4 | 5 |
| Resin | Polylactic | 99.9 | 99.4 | 98.9 | 96.9 | 94.9 | 89.9 |
| composition | acid | | | | | | |
| (mass %) | Cellulose | 0 | 0.5 | 1 | 3 | 5 | 10 |
| | nanofiber | | | | | | |
| | particle | | | | | | |
| | Heat | 0.05 | 0.05 | 0.05 | 0.05 | 0.05 | 0.05 |
| | stabilizer | | | | | | |
| | Antioxidant | 0.05 | 0.05 | 0.05 | 0.05 | 0.05 | 0.05 |
| Evaluation | Impact | 2.4 | 2.8 | 3.4 | 3.4 | 3.6 | 3.5 |
| | strength: | | | | | | |
| | notched | | | | | | |
| | (kJ/m²) | | | | | | |
| | Tensile | 2111 | 2095 | 2188 | 2138 | 2165 | 2271 |
| | flexibility | | | | | | |
| | (MPa) | | | | | | |

In the examples and control example, polylactic acid was TE-1030 produced by UNITIKA LTD, however, other polylactic acid products (for example, LACEA produced by Mitsui Chemicals, Inc, Ingeo produced by NatureWorks LLC., etc.) could also be used.

1. A biodegradable resin composition, comprising:
a biomass nanofiber and a biodegradable resin,
wherein a content of the biomass nanofiber ranges from 0.1% to 10% by mass.

2. The biodegradable resin composition according to claim 1, wherein the content of the biomass nanofiber ranges from 0.8% to 8% by mass.

3. The biodegradable resin composition according to claim 1, wherein the biomass nanofiber is a mechanical defibrating biomass nanofiber.

4. The biodegradable resin composition according to claim 2, wherein the biomass nanofiber is a mechanical defibrating biomass nanofiber.

5. The biodegradable resin composition according to claim 1, wherein a polymerization degree of the biomass nanofiber ranges from 150 to 900.

6. The biodegradable resin composition according to claim 2, wherein a polymerization degree of the biomass nanofiber ranges from 150 to 900.

7. The biodegradable resin composition according to claim 3, wherein a polymerization degree of the biomass nanofiber ranges from 150 to 900.

8. The biodegradable resin composition according to claim 4, wherein a polymerization degree of the biomass nanofiber ranges from 150 to 900.

9. A biomass nanofiber particle, formed by a plurality of biomass nanofiber and used in the biodegradable resin composition according to claim 1, wherein:
the biomass nanofiber particle is granular and an aggregate of the plurality of the biomass nanofibers with an average fiber diameter of 5 nm to 50 nm,
a polymerization degree of the plurality of biomass nanofiber ranges from 150 to 900,
a water content of the biomass nanofiber particle is less than 9% by mass, and
a median particle size of the biomass nanofiber particle ranges from 3 μm to 15 μm.

10. The biomass nanofiber particle according to claim 9, wherein a content of at least one functional groups selected from a group consisting of carboxyl, carboxymethyl, phosphate, sulfate, phosphite, xanthate, and sulfo is less than 0.1 mmol/g.
